(19) United States
(12) Patent Application Publication
(10) Pub. No.: US 2023/0062351 A1
(43) Pub. Date: Mar. 2, 2023

(54) METHODS, SYSTEMS AND STORAGE MEDIUMS FOR EMPLOYMENT MANAGEMENT IN A SMART CITY BASED ON INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Haitang XIANG, Chengdu (CN); Xiaojun WEI, Chengdu (CN); Zhihui WEN, Chengdu (CN)

(73) Assignee: CHENGDU QINCHUAN IOT TECHNOLOGY CO., LTD., Chengdu (CN)

(21) Appl. No.: 18/046,932

(22) Filed: Oct. 16, 2022

(30) Foreign Application Priority Data
Aug. 30, 2022 (CN) 202211044778.3

(51) Int. Cl. G06Q 10/10

(52) U.S. Cl. CPC G06Q 10/1053

(57) ABSTRACT

A method for employment management and Internet of Things system are provided. The system comprises a user platform, a service platform, a management platform; the method being executed by the management platform, and the method comprising: obtaining company-related information; determining a target industry and a target company based on the company-related information and a query condition; predicting a turnover rate and a hiring rate of the target company based on company-related information of the target company; returning the turnover rate and the hiring rate of the target company to the user platform through the service platform; and generating first warning information based on the turnover rate that meets a first preset requirement, and/or generating second warning information based on the hiring rate that meets a second preset requirement, and returning the first warning information and/or the second warning information to the user platform based on the service platform.

### CROSS-REFERENCE TO RELATED APPLICATIONS

This application claims priority of Chinese Patent Application CN 202211044778.3, filed on Aug. 30, 2022, the contents of which are hereby incorporated by reference to its entirety.

### TECHNICAL FIELD

This present disclosure relates to the field of Internet of Things and cloud platforms, and in particular to a method, system, and a storage medium for employment management in a smart city based on Internet of Things.

### BACKGROUND

With the development of economy, more and more enterprises, and the development status of each enterprise is complex and changeable. Some enterprises do not have a clear perception of relevant government policies and industry environment, and the government platform does not have enough understanding of the operation of each company, which makes the formulation of relevant assistance or guidance policies often lag behind, and the efficiency is low.

Therefore, it is necessary to propose a method, and a system for employment management in a smart city based on Internet of Things, which can grasp the employment problems of enterprises in time, and facilitate the technical and accurate acquisition of enterprise employment problems by enterprise management agencies such as the government, and then strengthen the management, so that the sound and stable development of the enterprise, at the same time, it can also facilitate the employees to have a comprehensive understanding of the employment situation of the enterprise.

### SUMMARY

This present disclosure provides a method for employment management in a smart city, which is realized by a system for employment management in a smart city based on Internet of Things. the system comprises a user platform, a service platform, a management platform; the method being executed by the management platform, and the method comprising: obtaining company-related information, where the company-related information includes at least one of regional information, industry information, company information, position information, and employee information; determining a target industry and a target company based on the company-related information and a query condition; obtaining the query condition based on the user platform, and transmitting the query condition to the management platform through the service platform based on the user platform; predicting a turnover rate and a hiring rate of the target company based on the company-related information of the target company; returning the turnover rate and the hiring rate of the target company to the user platform through the service platform; generating first warning information based on the turnover rate that meets a first preset requirement, and/or generating second warning information based on the hiring rate that meets a second preset requirement, and returning the first warning information and/or the second warning information to the user platform based on the service platform.

This present disclosure provides a system for employment management in a smart city, which is realized by a system for employment management in a smart city based on Internet of Things, the system comprising a user platform, a service platform, a management platform; the management platform is configured to perform following operations, including: obtaining company-related information, where the company-related information includes at least one of regional information, industry information, company information, position information, and employee information; determining a target industry and a target company based on the company-related information and a query condition; obtaining the query condition based on the user platform, and transmitting the query condition to the management platform through the service platform based on the user platform; predicting a turnover rate and a hiring rate of the target company based on the company-related information of the target company; returning the turnover rate and the hiring rate of the target company to the user platform through the service platform; and generating first warning information based on the turnover rate that meets a first preset requirement, and/or generating second warning information based on the hiring rate that meets a second preset requirement, and returning the first warning information and/or the second warning information to the user platform based on the service platform.

This present disclosure provides a non-transitory computer-readable storage medium, comprising a set of instructions, wherein when executed by at least one processor, the computer implements the method for employment management in the smart city.

### BRIEF DESCRIPTION OF THE DRAWINGS

The present disclosure is further described in terms of exemplary embodiments. These exemplary embodiments are described in detail with reference to the drawings. These embodiments are not limited, in these embodiments, the same number denote the same structure, with:

FIG. 1 is a schematic diagram illustrating an application scenario of a system for employment management in a smart city based on Internet of Things according to some embodiments of the present disclosure;

FIG. 2 is a schematic diagram illustrating a framework of a system for employment management in a smart city based on Internet of Things according to some embodiments of the present disclosure;

FIG. 3 is an exemplary flowchart illustrating a method for employment management in a smart city according to some embodiments of this present disclosure;

FIG. 4 is an exemplary flowchart of determining a target industry and a target company according to some embodiments of the present disclosure;

FIG. 5 is a schematic flowchart of predicting a turnover rate and a hiring rate of a target company according to some embodiments of the present disclosure;

FIG. 6 is a schematic diagram of determining a target company subgraph according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “device,” “unit,” and/or “module” used herein are one method to distinguish different components, elements, parts, sections, or assemblies of different levels. However, the terms may be displaced by another expression if they achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments of the present disclosure. It is to be expressly understood the operations of the flowcharts may be implemented not in order. Conversely, the operations may be implemented in an inverted order, or simultaneously. Moreover, one or more other operations may be added to the flowcharts. One or more operations may be removed from the flowcharts.

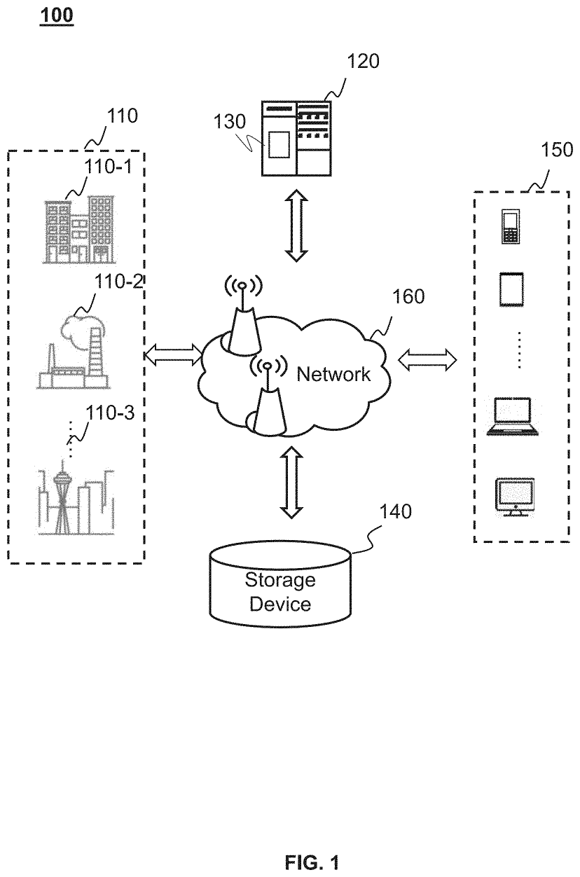

FIG. 1 is a schematic diagram illustrating an application scenario of a system for employment management in a smart city based on Internet of Things according to some embodiments of the present disclosure. In some embodiments, the application scenario 100 may include a company 110, a server 120, a processing device 130, a storage device 140, a user terminal 150, and a network 160.

In some embodiments, the company 110 may include companies of various industries and sizes within a governmental jurisdiction, for example, a technology company 110-1, a manufacturing plant 110-2, a media company 110-3, or the like.

In some embodiments, the server 120 may be a single server or a group of servers. The group of servers may be centralized or distributed.

In some embodiments, the server 120 may include the processing device 130. The processing device 130 may be used to obtain information and to analyze and process the collected information to perform one or more functions described in this present disclosure. For example, the processing device 130 may obtain related information of the company 110 (also referred to as the company-related information 110) (e.g., number of people, industry, etc.) to determine a target industry and a target company. As another example, the processing device 130 may predict a turnover rate and a hiring rate of the target company based on the target company and its related information.

In some embodiments, the processing device 130 may include one or more processing engines (e.g., single-chip processing engines or multi-chip processing engines).

The storage device 140 may be used to store data and/or instructions, e.g., the storage device 140 may be used to store information and/or data related to the company 110. The storage device 140 may obtain data and/or instructions from, for example, the server 120, or the like. In some embodiments, the storage device 140 may store data and/or instructions used by the processing device 130 to perform or use to accomplish the exemplary methods described in this present disclosure.

The user terminal 150 may refer to one or more terminal devices or software used by a user. In some embodiments, the user terminal 150 may include a mobile device with a display, a tablet computer, or the like. In some embodiments, the user may view the hiring rate and the turnover rate of the target company through the user terminal 150, and may also receive related information, such as first warning information, second warning information, etc., through the terminal.

The network 160 may provide a channel for the exchange of information and/or data. In some embodiments, the information may be exchanged between the company 110, the server 120, the storage device 140, and the user terminal 150 through the network 160. For example, data and/or information about the company 110 may be transmitted to the server 120 via the network 160 and stored in the storage device 140. As another example, the user terminal may receive early warning information, or the like sent by the server 120 through the network 160.

It should be noted that the application scenario is provided for illustrative purposes only and is not intended to limit the scope of this present disclosure. Those ordinarily skilled in the art may make various modifications or changes based on the description of the present specification. For example, the application scenario may also include a database. As another example, the application scenario may be implemented on other devices to achieve similar or different functions. However, changes and modifications do not deviate from the scope of the present disclosure.

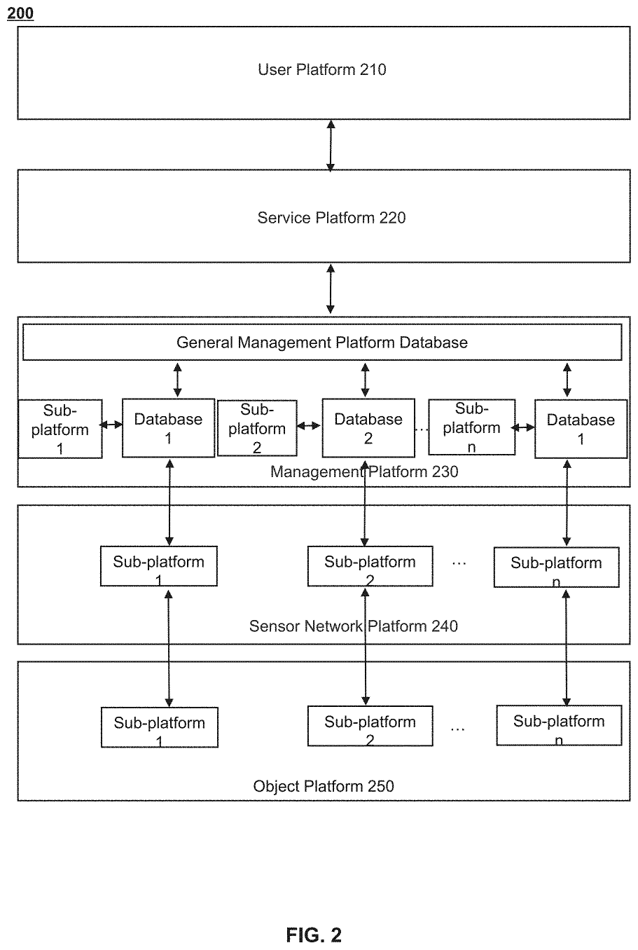

FIG. 2 is a schematic diagram illustrating a framework of a system for employment management in a smart city based on Internet of Things according to some embodiments of the present disclosure.

As shown in FIG. 2, the system 200 for employment management in the smart city based on the Internet of Things includes a user platform 210, a service platform 220, a management platform 230, a sensor network platform 240 and an object platform 250 that interact in sequence.

The user platform 210 is a user-driven platform. In some embodiments, the user platform 210 is configured as a terminal device that may feed back employment policy information to a user. For example, the user platform 210 may provide the user with information such as the company's hiring rate and turnover rate.

In some embodiments, the user platform 210 may interact downward with the service platform 220. For example, issuing a query instruction for employment management information to the service platform 220, receiving employment management information uploaded by the service platform 220, or the like.

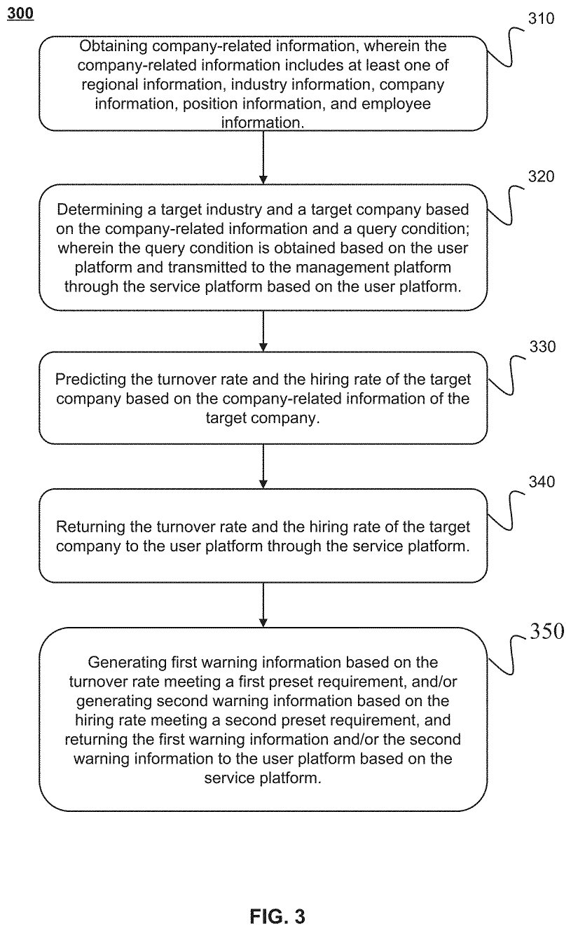

In some embodiments, the query instruction for the employment management information includes industry query conditions and company query conditions. For more information, please refer to the relevant part of FIG. 3. In some embodiments, the employment management information includes the company's headcount, industry, hiring rate, turnover rate, or the like.

The service platform 220 refers to a platform that provides employment management information query service for a user. In some embodiments, the service platform is configured as a first server in a centralized arrangement. The centralized arrangement means that receiving, processing and sending of data or/and information are performed by the same platform.

In some embodiments, the service platform 220 may interact downward with the management platform 230. For example, issuing a query instruction for employment management information to the management platform 230, receiving employment management information uploaded by the management platform 230, or the like.

In some embodiments, the service platform may also interact upwardly with the user platform. For example, receiving the employment management information query instruction issued by the user platform 210, uploading the employment management information to the user platform 210, and so on.

In some embodiments, the management platform 230 includes a general management platform database, multiple management sub-platforms, and multiple sub-platform databases, wherein the multiple management sub-platforms correspond to the multiple sub-platform databases one-to-one; the multiple management sub-platforms include at least one of a regional management sub-platform, an industry management sub-platform, a company management sub-platform, a position management sub-platform, and an employee management sub-platform of an enterprise. In some cases, the terms “enterprise” and “company” may be used interchangeable.

In some embodiments, the management platform 230 is a platform for implementing a method for employment management in a smart city. In some embodiments, the management platform 230 may process employment information of various industries and companies (e.g., predict the hiring rate and turnover rate of various companies), determine employment policies, etc., in response to the user's query requirements.

In some embodiments, the management platform 230 is configured as a second server in a combined front-fraction arrangement. The combined front-fraction arrangement refers to that each sub-platform processes and manages the corresponding data, and transmits the processed data to each sub-platform database, each sub-platform database further uploads the processed data to a general platform database, and the general platform database uploads the aggregated and processed data to other platforms.

In some embodiments, the sub-platforms of the management platform 230 may be multiple sub-platforms divided according to data types, sources, or the like. For example, regional management sub-platform, industry management sub-platform, employee management sub-platform, etc.

In some embodiments, the data interaction of the management platform 230 includes: each management sub-platform may process and manage corresponding data. For example, social security-related data paid by personnel is managed on the social security management platform; as another example, enterprise-related data (such as hiring registration, turnover registration, etc.) are uploaded to the enterprise management platform for management; each management sub-platform transmits the processed data to each management sub-platform database; each management sub-platform database further uploads the processed data to the general management platform database; the general management platform database processes the aggregated and processed employment-related data to obtain forecast information and uploads it to the service platform. The data uploaded to the service platform is the overall employment situation aggregated by relevant industries.

In some embodiments, the management platform 230 may interact with the service platform 220 upwardly. For example, receiving employment information query instructions issued by the service platform, uploading employment information to the service platform, etc.

In some embodiments, the management sub-platforms process related data in different regions and then aggregate them into the general database, which may reduce the data processing pressure of the entire management platform and at the same time aggregate the data of each independent sub-platform for unified management. The sub-platform database and the general database belong to the government, which may facilitate the government to uniformly grasp the overall situation of the city's employment.

In some embodiments, the system for employment management in the smart city based on the Internet of Things further includes a sensor network platform 240. The sensor network platform 240 refers to a platform for transmitting company information to the management platform. In some embodiments, the sensor network platform 240 includes multiple sensor network sub-platforms, and the multiple sensor network sub-platforms are in one-to-one correspondence with the sub-platform databases of the multiple management platforms. In some embodiments, the multiple sensor network sub-platforms are respectively used to transmit different company-related information (e.g., regional information, industry information, company information, etc.) to the sub-platform database of the corresponding management sub-platform.

In some embodiments, the system for employment management in the smart city based on the Internet of Things further includes an object platform 250. The object platform 250 may obtain company-related information, and transmit the company-related information to multiple sub-platform databases based on the sensor network platform.

In some embodiments, the object platform 250 includes multiple object sub-platforms, and the multiple object sub-platforms respectively correspond to the multiple sensor network sub-platforms one-to-one. In some embodiments, the multiple object sub-platforms may collect different company-related information (e.g., regional information, industry information, company information, etc.), and transmit the company-related information through one-to-one corresponding multiple sensor network sub-platforms to different sub-platform databases.

FIG. 3 is an exemplary flowchart illustrating a method for employment management in a smart city according to some embodiments of this present disclosure. In some embodiments, the process 300 may be executed by the management platform. As shown in FIG. 3, the process 300 includes the following steps:

Step 310: obtaining company-related information, where the company-related information includes at least one of regional information, industry information, company information, position information, and employee information.

The company-related information refers to some information related to the company, for example, regional information, industry information, company information, position information, employee information, etc. of the company.

The regional information refers to information about the region where the company is located, such as regional location, regional economic development, etc.

The industry information refers to information about the industry in which the company operates. For example, the industry category of the company, the local development of the industry, the influence of industry development on local economic development, and the nature of the industry (such as service industry, high-tech industry, etc.), etc.

The company information refers to the basic information of the company. For example, company name, scale, status of company social security payment, industry field, main business, position division, employee status, etc.

The position information refers to information related to the position of the company. For example, the number of positions, types of positions, job responsibilities, and job requirements (such as professional ability, work experience, age, gender, body height, personality, etc.), etc.

The employee information refers to information about employees in the company. For example, professional skills, comprehensive ability, age, gender, body height, etc.

In some embodiments, the company-related information may be obtained through the management platform. In some embodiments, the company-related information may be obtained by manual input, and may also be obtained in association with other government platforms (e.g., social security platforms, tax authorities, etc.).

In some embodiments, obtaining the company-related information includes: obtaining the company-related information based on multiple management sub-platforms, and transferring the information to the general management platform database through the multiple sub-platform databases.

Step 320: determining a target industry and a target company based on the company-related information in combination with a query condition. the query condition is obtained based on the user platform and transmitted to the management platform through the service platform based on the user platform.

The query condition refers to the condition set by a user when querying the company and/or industry the user wants to know. The query condition includes an industry query condition and a company query condition. In some embodiments, the industry query condition refers to the query condition set by the user when querying about the industry that the user wants to know. For example, the user may set the industry query condition as software development industry. In some embodiments, the company query condition refers to the query condition set by the user when querying the company that the user wants to know. For example, the user may set the company query condition to be a company with more than 50 employees.

In some embodiments, the query condition may be obtained based on the user platform. In some embodiments, the query condition may be preset on the user platform for the user to select. For example, the company query condition (such as company number 1-50, 50-100; main chemical business, main software development business, etc.), industry query condition (such as real estate industry, financial industry, etc.) may be preset for the user to select and then the query condition selected by the user is obtained.

The target industry refers to the industry that meets the user's industry query condition. For example, if the user's industry query condition is the real estate industry, the target industry is the real estate industry, including house buying and selling, leasing, or the like.

The target company refers to the company that meets the user's company query condition. For example, if the user's company query condition is a company with more than 50 employees, the target company is all companies with more than 50 employees.

In some embodiments, the target industry and target company may be determined by the management platform based on the query condition.

In some embodiments, determining the target industry and the target company in combination with the query condition based on the company-related information includes: determining the target industry and the target company in combination with the query condition based on the company-related information in the general management platform database.

For example, if the user's query condition is a company with more than 50 employees in the media industry, which is mainly engaged in advertising planning business, the management platform database may determine the media industry as the target industry based on the stored company-related information in combination with the query condition, and all companies with more than 50 employees engaged in advertising planning business as the target company.

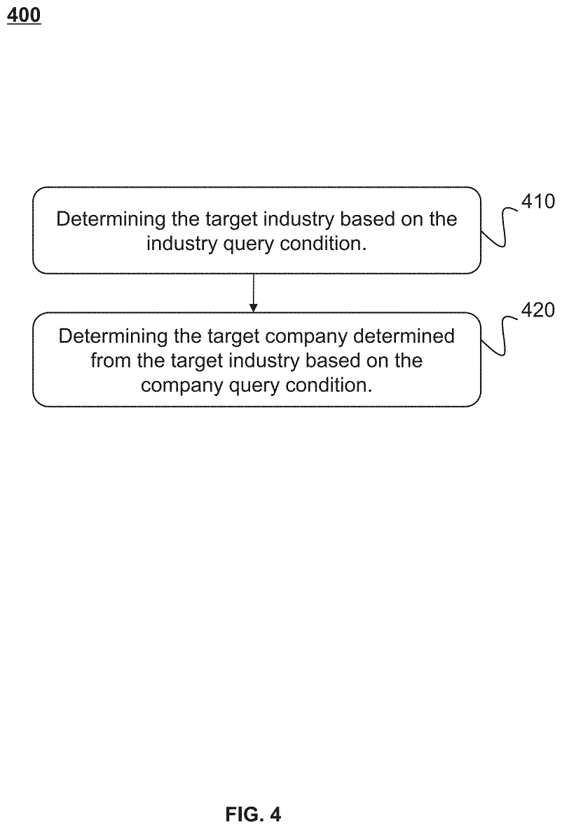

In some embodiments, determining the target industry and the target company in combination with the query condition based on company-related information includes: determining the target industry based on the industry query condition; determining the target company from the target industry based on the company query condition. For more information about identifying the target industry and the target company, please refer to the relevant parts of FIG. 4.

In some embodiments, the query condition may be issued by the user platform to the service platform, and then the service platform may issue the query condition to the management platform.

Step 330, predicting the turnover rate and the hiring rate of the target company based on the company-related information of the target company.

The turnover rate refers to the percentage of employees who leave the company during a certain period of time (e.g., one month, one year, etc.), which may be determined by the percentage of the number of departures and the cumulative number of registered employees during the period (the sum of the number of incumbents and the number of quitters at the end of the period). For example, if a company has 40 employees at the end of January and 10 people left in January, the company's turnover rate in January is 20%.

The hiring rate refers to the percentage of employees who are hired by the company during a certain period of time (e.g., one month, one year, etc.), and may be determined by the percentage of employees who are hired and those who should be recruited during that period. For example, if a company hires 10 people in January and 5 people are entered the company, then the company's hiring rate in January is 50%.

In some embodiments, the target company's turnover rate and hiring rate may be predicted based on the company's historical data. For example, if the historical average monthly turnover rate of a target company is 5% and the monthly hiring rate is 60%, the predicted monthly turnover rate of the company may be 5% and the predicted monthly hiring rate may be 60%.

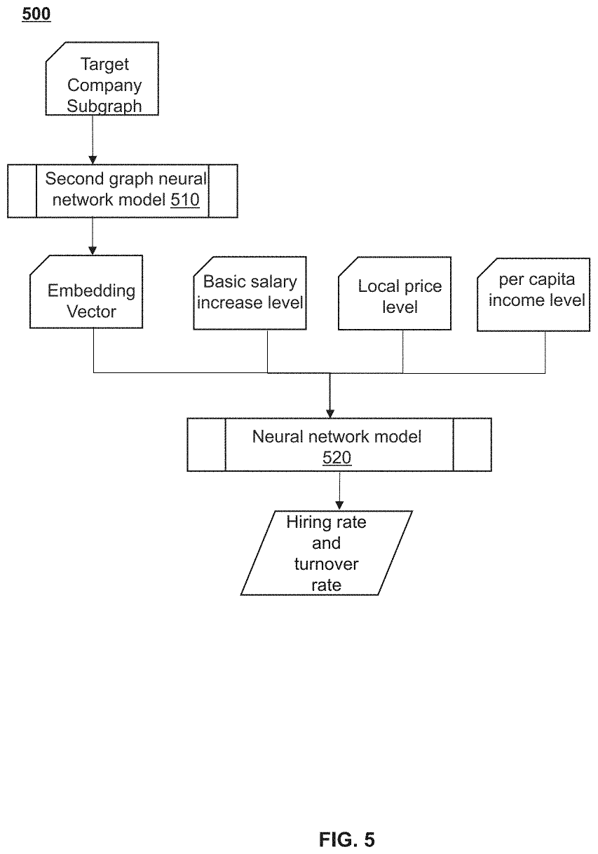

In some embodiments, the target company's turnover rate and hiring rate may also be obtained through a prediction model. Based on the company-related information of the target company, the target company's turnover rate and hiring rate are predicted through a prediction model. For a detailed description of the prediction model, please refer to the related part of FIG. 5.

Step 340: returning the turnover rate and the hiring rate of the target company to the user platform through the service platform.

In some embodiments, the management platform may upload the turnover rate and the hiring rate of the target company to the service platform, and then the service platform returns the turnover rate and the hiring rate to the user platform.

Step 350: generating first warning information based on the turnover rate meeting a first preset requirement, and/or generating second warning information based on the hiring rate meeting a second preset requirement, and returning the first warning information and/or the second warning information to the user platform based on the service platform.

The first preset requirement is a preset threshold used to measure the resignation situation of the target company. In some embodiments, the first preset requirement may be determined based on the difference between the target company's predicted turnover rate and the average turnover rate of the industry. The first preset requirement may be set manually, for example, the first preset requirement may be 7%. In some embodiments, the first preset requirement may also be preset differently according to different situations of the industry. For example, a higher first preset requirement may be preset for an industry with high liquidity, for example, the first preset requirement of a real estate sales company may be set to 10%; as another example, a lower first preset requirement may be preset for an industry with low liquidity, for example, the first preset requirement of a software development company may be 5%.

The turnover rate meeting the first preset requirement refers to that the difference between the predicted turnover rate and the average turnover rate of the industry is greater than the first preset requirement. For example, the first preset requirement of a software development company is 5%, and the prediction model predicts that the company's turnover rate is 20%, the average turnover rate of the software development industry in this region is 8%. If the difference between the predicted turnover rate and the average turnover rate of the industry is 12% greater than the first preset requirement of 5%, the company meets the first preset requirement.

The first warning information refers to the warning information generated to the user for the target company that meets the first preset condition, for example, warning users that the company's turnover rate is higher than the average industry turnover rate, so choose carefully. In other embodiments, the first warning information may also be warning information generated by the government for the target company that meets the first preset condition, for example, alerting the government that the company's turnover rate is higher than the industry average and may be problematic.

In some embodiments, the first warning information may be determined by the service platform based on the predicted turnover rate of the prediction model and relevant information of the target company, and returned to the user platform based on the service platform.

The second preset requirement is a preset threshold used to measure the hiring situation of the target company. In some embodiments, the second preset requirement may be determined based on the difference between the average industry hiring rate and the company's predicted hiring rate. The second preset requirement may be set manually, for example, the second preset requirement may be 4%. In some embodiments, the second preset requirement may also be preset differently according to different situations of the industry. For example, a higher second preset requirement may be preset for an industry with high liquidity, for example, the second preset requirement of a real estate sales company may be set to 10%; as another example, a lower second preset requirement may be preset for an industry with low liquidity, for example, the second preset requirement of a software development company may be 5%.

In some embodiments, when the target company's predicted hiring rate is lower than the industry average employment rate, the target company meets the second preset requirement refers to that the difference between the industry average employment rate and the target company's predicted employment rate is greater than the second preset requirement. For example, if the second preset requirement of an advertising planning company is 6%, and the prediction model predicts that the company's hiring rate is 50%, the average hiring rate of the advertising planning industry in this region is 70%, and the difference between the industry average hiring rate and the predicted hiring rate is 20%, which is greater than the second preset requirement of 6%, then the company meets the second preset requirement.

In some embodiments, when the target company's predicted hiring rate is greater than the industry average hiring rate, the target company meets the second preset requirement may also be that the difference between the target company's predicted hiring rate and the industry average hiring rate is greater than the second preset requirement. For example, if the second preset requirement of an advertising planning company is 6%, and the prediction model predicts that the company's hiring rate is 80%, the average hiring rate of the advertising planning industry in this region is 70%. If the difference between the predicted hiring rate and the industry average hiring rate is 10%, which is greater than the second preset requirement of 6%, the company meets the second preset requirement.

The second warning information refers to the warning information generated to the user for the target company that meets the second preset condition. For example, warning users that the company's hiring rate is below the average industry hiring rate, so choose carefully. As another example, warning users, the company's hiring rate is higher than the average industry hiring rate, please choose carefully. In other embodiments, the second warning information may also be warning information generated by the government for the target company that meets the second preset condition. For example, warning the government that the company's hiring rate is lower than the average industry hiring rate and there may be problems. At the same time, it may also be used as auxiliary information when formulating employment assistance policies.

In some embodiments, the second warning information may be determined by the service platform based on the predicted hiring rate of the prediction model and related information of the target company, and returned to the user platform based on the service platform.

In some embodiments, the target company is determined based on company-related information and the query condition, the target company's hiring rate and turnover rate are predicted based on the prediction model, and warning information is generated, which can facilitate the user to find the target company and at the same time understand the relevant situation of the target company more clearly, thereby improving the employment efficiency of the user. At the same time, it is also convenient for the relevant government departments to understand the operation of the companies in the region, which is convenient for the government to support and manage these companies.

FIG. 4 is an exemplary flowchart of determining a target industry and a target company according to some embodiments of the present disclosure. In some embodiments, the process 400 may be performed by the management platform.

Step 410, determining the target industry based on the industry query condition.

In some embodiments, the industry query condition may include industry requirements that meet the filter conditions in some respects. For example, the industry query condition may include filter conditions for economic development. By way of example only, the industry query condition may be that economic development is on an upward trend, economic development is on a downward trend, economic development rate is lower than an average level, or the like.

In some embodiments, the industry corresponding to the industry information that meets the industry query condition may be used as the target industry. The number of target industries may be multiple. For example, the industry query condition may be an industry with an upward trend in economic development, and the economic development of industry A, industry B, and industry C are rising, falling, and rising, respectively, and the target industries are industry A and industry C.

Step 420, determining the target company determined from the target industry based on the company query condition.

In some embodiments, the company query condition may include the condition for filtering company-related information. The company query condition may include a condition for filtering at least one type of company-related information among regional information, industry information, company information, position information, and employee information. For example, the company query condition may include a downward trend in the company's output value, a gradual reduction in company size, the number of employees in the company below or above a preset threshold, and the age and gender structure of the company's employees.

In some embodiments, a company in the target industry corresponding to the company-related information that meets the company query condition may be used as the target company. The number of target companies may be one or more. For example, the company query condition may be a company with more than 100 employees. The target industry includes company 1, company 2, and company 3. The number of employees is 80, 90, and 110, respectively, and the target company is company 3.

In some embodiments, based on the enterprise knowledge graph, determining the target industry and the target company may include: determining the target industry based on the node attribute of the industry, and determining the target company based on the node attribute of the company.

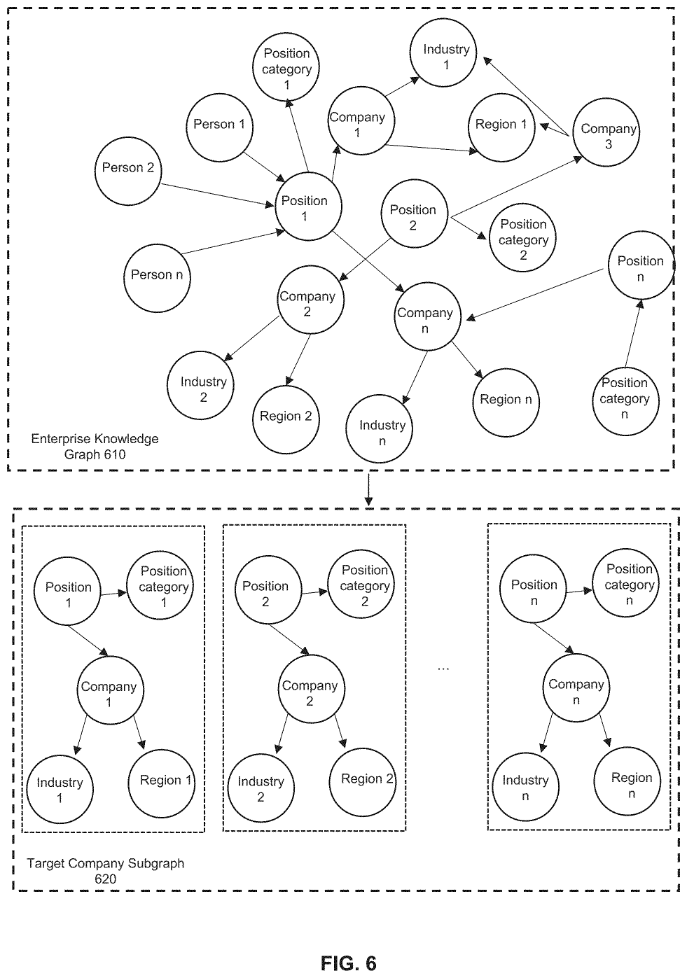

The enterprise knowledge graph may refer to a semantic network graph constructed based on company-related information. As shown in FIG. 6, the enterprise knowledge graph 610 may include node data as well as edge data.

The node data may include regional nodes, industry nodes, company nodes, employee nodes, position nodes, and position category nodes, a node contains a corresponding node attribute.

A regional node corresponds to a region. Regions may be multiple. For example, the regional nodes may be Beijing, Shanghai, or Beijing Chaoyang District. The node attributes corresponding to the regional nodes may include regional economic development, economic structure, development speed, or the like. The development of regional economy may show an upward, downward and steady trend of development.

An industry node corresponds to an industry, and a node attribute corresponding to an industry node may include industry nature, industry economic development, or the like. According to the nature of the industry, the industry may be divided into textile industry, communication industry, catering industry, etc. The economic development of the industry may include upward, downward, and steady trends in the development of the industry. The economic development of the industry may be determined based on the comparison result of the current industry output value and the historical output value.

The company node corresponds to a company, and the node attributes corresponding to the company node may include the company's tax amount, the number of employees, and the company's total output value. In some embodiments, the company's economic development, company size, etc., may be determined based on the company's tax payment, the number of employees, and the company's total output value. The economic development of the company may include upward, downward, and steady trends in the development of the industry. For example, when the company's tax payment in the current year exceeds the tax payment in the previous year, the company's economic development is in an upward stage. As another example, when a company has fewer employees this year than last year, the company is downsized.

A position node corresponds to a position. Positions may include financial positions, personnel positions, logistics positions, operator positions, etc. A node attribute corresponding to the position node may include the current number of people, the number of recruits, or the like.

The position category node corresponds to the category described by a position, and the position category may include management positions, technical positions, administrative positions, or the like. The node attribute corresponding to the position category node may include the number of employees in the position category, the resignation situation, the hiring situation, or the like. Through the position category node, the hiring and turnover status of employees in each category may be determined, and the distribution of employees corresponding to the category of positions may be understood.

An employee node corresponds to an employee of a company. A node attribute corresponding to the employee node may include the age, tax amount, educational background, gender, etc. of each employee. The employee-related information such as the age and gender of the company's employees may be determined based on the corresponding attribute of the employee node.

The edge data of the enterprise knowledge graph includes a type of the edge and an attribute of the edge, wherein the type of the edge includes at least one of a first type of edge, a second type of edge, a third type of edge, a fourth type of edge, and a fifth type of edge. The attribute of the edge may be represented by a vector.

The first type of edge points from the company node to the industry node to which the company node belongs, and may be used to reflect the companies included in an industry and the industry to which each company belongs. The edge attributes of the first type of edge may include the degree of contribution of the company to the development of its industry. In some embodiments, the proportion of the output value of the company to the total output value of the industry to which the company may be used as the degree of contribution of the company to the development of the industry to which the company belongs.

The second type of edge points from the company node to the regional node where the company is located, and may be used to reflect the region where each company is located and the companies included in each region. The edge attribute of the second type of edge may include the degree of the company's contribution to the economy of the region in which it is located. The proportion of the company's output value in the total output value of the region where the company is located may be taken as the company's contribution to the economy of the region where the company is located.

The third type of edge points from the position node to the company node containing the position node, and may be used to reflect the positions included in a company. The edge attribute of the third type of edge may include the proportion of the number of positions and the contribution of positions to the company. In some embodiments, the degree of contribution of the position to the company may be based on the degree of completion of the company's indicators (e.g., performance indicators) by the employees of the position.

The fourth type of edge points from the employee node to the position node to which the employee belongs, and may be used to reflect the employees included in a position. The edge attribute of the fourth type of edge may include employee employment information, such as resignation and resignation state or employee's hiring and hiring state, the company to which the employee belongs, and so on.

The fifth type of edge points from the position node to the position category node corresponding to the position node, which may reflect the category described by the position.

In some embodiments, region information, industry information, company information, position information, employee information, etc. in the company-related information may be determined based on node attributes and edge attributes of nodes of the enterprise knowledge graph. For example, the region information in the company-related information may be determined based on the regional nodes of the enterprise knowledge graph and the edge attributes of the second type of edge. For a detailed description about company-related information, please refer to FIG. 3.

In some embodiments, the target industry may be determined based on the industry node attribute and the industry query condition. In some embodiments, the industry corresponding to the attribute node of the industry that meets the industry query condition may be corresponding to the target industry. For example, the industry query condition may be an industry with a downward trend in economic development. Based on the enterprise knowledge graph, it is determined that the node attributes corresponding to industry 1, industry 2, and industry n are upward, downward, and upward, respectively, and the target industry is industry 2.

In some embodiments, target companies may be determined from target industries based on node attributes and a company query condition. For example, the company query condition may include conditions such as the query tax amount, companies whose number of employees is greater than a preset value, or the like. In some embodiments, the company corresponding to the node attribute that meets the company query condition may be used as the target company. For example, the company query condition may be a company in the decoration industry with more than 100 employees. Based on the enterprise knowledge graph, companies with the first type of edge in the decoration industry are determined, including company 1, company 2, and company n, the number of employees corresponding to the company node attribute is 80, 90 and 110 respectively, then the target company is company n.

The target industry and target company are determined based on the knowledge graph, and thus the target industry, target company and their relationship can be determined intuitively, which can improve the efficiency of finding the target industry and target company and can improve the efficiency of understanding the employment situation of the target industry and target company.

In some embodiments, the node attributes of nodes of the enterprise knowledge graph may include mandatory attributes and optional attributes. The mandatory attributes may refer to general attributes that the node has, and the optional attributes may refer to special attributes that the node has. For example, the mandatory attributes of an industry node may include the nature of the industry and the economic development of the industry, and the optional attributes of the industry node may include the business engaged in by the industry, the degree of contribution to the society, or the like. As another example, the mandatory attributes of the company node may include the company's tax payment, the number of employees, the company's total output value, the company's economic development, the company's scale, etc., and the optional attributes of the company node may include the company's position in the region to which it belongs.

In some embodiments, the target industry and the target company may be determined based on the industry query condition and the mandatory attributes of the node, and the target industry and the target company may be adjusted based on the optional attributes of the node.

For example, based on the company query condition and the mandatory attributes of the company node, candidate target companies are determined from company nodes that have a first type of edge with the target industry, the candidate target companies are adjusted based on the optional attributes of the company nodes corresponding to each candidate target company to obtain the target company.

In some embodiments, adjustment may refer to further restricting candidate target industries and/or candidate target companies based on optional attributes of company nodes, then, the target company is determined from the candidate target companies, thereby increasing the matching degree between the target company and the query condition.

By way of example only, in practice, the input of query conditions is not standard, that is, it does not correspond to the node attributes of the enterprise knowledge graph, and new attributes may be dynamically obtained from company-related information as optional attributes of industry and/or company nodes. For example, the company query condition may be a time-honored enterprise with high output value in the liquor industry, but there is no corresponding attribute in the enterprise knowledge graph to determine whether it is a time-honored enterprise. Therefore, the age of company establishment may be added as an optional attribute of the company node, so as to further modify the candidate target company based on the optional attribute to obtain the final target company.

Adjusting the target company and/or target industry through optional attributes can improve the query rate, and at the same time obtain more accurate target companies and/or target industries that meet the query conditions, and also obtain more accurate employment information.

The target industry may be determined based on the industry query condition, and the target company may be determined from the target industry based on the company query condition. By narrowing the scope to determine the target company, the target company can be determined faster and more convenient, so that the employment situation of the target company can be obtained more quickly.

FIG. 5 is a schematic flowchart of predicting a turnover rate and a hiring rate of a target company according to some embodiments of the present disclosure.

In some embodiments, the target company's turnover rate and hiring rate may be predicted based on company-related information of the target company including: based on the company-related information of the target company, the target company's turnover rate and hiring rate are predicted through a prediction model.

In some embodiments, the prediction model may be used to predict turnover and hiring rates for a target company. The prediction model may be a machine learning model. For example, Deep Neural Networks (DNN), Convolutional Neural Networks (CNN), Recurrent Neural Networks (RNN), etc.

In some embodiments, an enterprise knowledge graph may be constructed based on company-related information, and node attributes of the target node may be determined based on company-related information of the target company, further, the target company subgraph may be obtained from the enterprise knowledge graph based on the node attribute of the target node, and the turnover rate and the hiring rate of the target company may be predicted based on the processing of the target company subgraph by the prediction model.

The target company subgraph 620 refers to a subgraph composed of nodes and edges in the enterprise knowledge graph that meet the query conditions. For details such as the obtaining of the target company subgraph, please refer to FIG. 6 and its related descriptions.

In some embodiments, the prediction model 500 may be a first graph neural network model. In some embodiments, the first graph neural network model may be used to process at least one target company subgraph to determine the hiring rate and the turnover rate corresponding to the target company subgraph.

As shown in FIG. 5, in some embodiments, the prediction model 500 may include a second graph neural network model 510 and a neural network model 520. In some embodiments, the second graph neural network model 510 may be used to process at least one target company subgraph to determine at least one corresponding embedding vector.

The embedding vector may be a feature vector corresponding to the target company subgraph, and elements therein may correspond to nodes and/or edges in the target company subgraph. For example, the embedding vector may be (a, b, c, d, e, f, g, h, i), wherein a, b, c, d, and e may respectively correspond to the company node, industry node, regional node, position node, and position category node in the same target company subgraph, g, h, i may represent a first type of edge between node company and node industry, a second type of edge between node company and node region, a third type of edge between node company and node position, a fifth type of edge between the node position and the node position category. In some embodiments, the element values may be determined based on attributes of nodes and/or edges, and specific corresponding relationships may be preset. For example, the element b corresponds to an industry node, and in the industry node, the textile industry corresponds to the element value b₁, the pharmaceutical company node corresponds to the element value b₂, and so on.

In some embodiments, the neural network model 520 may be used to process the at least one embedding vector to determine the hiring rate and the turnover rate corresponding to the at least one target company subgraph.

In some embodiments, the prediction model may be obtained through joint training of the second graph neural network model and the neural network model. For example, the training sample is input into the initial second graph neural network model, that is, the historical company subgraph, and the historical embedding vector corresponding to the historical target company subgraph is obtained; then the output of the initial second graph neural network model is used as the input of the initial neural network model. During the training process, a loss function is established based on the label and the output of the initial neural network model to update the parameters of the initial prediction model, when the loss function of the initial prediction model meets the preset conditions, the model training is completed, wherein the preset conditions may be that the loss function converges, the number of iterations reaches a threshold, etc.

In some embodiments, the training samples may be obtained based on historical company subgraphs, which may be determined based on historically relevant data of the company. The labels of the training samples may be the company's historical hiring rates and historical turnover rates. The labels may be labeled manually.

In some embodiments, the input of the neural network model 520 may further include the basic salary increase level, price level, and per capita income level in the region to which the target company belongs. The basic salary increase level, price level, and per capita income level of the target company's region may be represented by vectors. For example, the vector (−5, 1, 8000) may indicate that the basic salary increase is negative 5%, the price level is 1, 1 represents the first level, and the per capita income level is 8,000 yuan/month. The basic salary increase level, price level, and per capita income level in the region of the target company's region may be obtained directly from the cloud platform outside the IoT, the price level and specific price information may be preset.

As shown in FIG. 5, the target company subgraph may be input into the second graph neural network model 510, and the embedding vector corresponding to the target company subgraph may be output. Further, the embedding vector corresponding to the subgraph of the target company output by the second graph neural network model 510, the basic salary increase level in the region to which the target company belongs, the price level, and the per capita income level are used as the input of the graph neural network 520, then the target company's predicted hiring and turnover rates may be output.

During training, the training samples may also include the historical basic salary increase level, historical price level, and historical per capita income level of the region to which the target company belongs.

The parameters of each layer of the prediction model may be obtained by joint training, and a more accurate prediction model may be obtained. When determining the hiring rate and turnover rate, the influence of the basic salary increase level, price level, and per capita income level on the employee's hiring rate and turnover rate in the target company's region is considered, that is, the basic salary increase level, price level, and per capita income level of the target company's region are added into the input data of the prediction model, thereby obtaining more accurate and more realistic employee hiring rates and turnover rates may be obtained and more accurate employment information may be obtained.

In some embodiments of this present disclosure, the employee's hiring rate and turnover rate predicted through the prediction model may be helpful in more accurately and efficiently determining the employee's hiring rate and turnover rate in the future time period, which can help users to understand the future development trend of the enterprise further improve the user perception of the company. According to the target company's hiring rate and turnover rate, the corresponding strategy may be determined, for example, when the hiring rate of the target company is low and the turnover rate is high, the government may provide employment assistance strategies. At the same time, for employees, they may also fully understand the target company based on the information obtained.

FIG. 6 is a schematic diagram of determining a target company subgraph according to some embodiments of the present disclosure.

In some embodiments, the enterprise knowledge graph may be constructed based on company-related information, and node attribute of the target node may be determined based on the company-related information of the target company, further, the target company subgraph may be obtained from the enterprise knowledge graph based on the node attribute of the target node.

The target company subgraph may refer to an enterprise knowledge subgraph containing nodes and edges that meet the query conditions, and the enterprise knowledge subgraph may be part or all of the enterprise knowledge graph. The target company's subgraphs may have one or more.

The target node may be a company node corresponding to the target company in the enterprise knowledge graph 610 and a node connected to the company node corresponding to the target company. The target node may include a company node corresponding to the target company, an industry node corresponding to the target industry with the first type of edge of the target company, a region node corresponding to the target region with the second type of edge, a position node corresponding to the target position with the third type of edge, and a position category node corresponding to the target position category with the fifth type of edge of the target position.

In some embodiments, the target node and its node attribute may be determined through the enterprise knowledge graph 610 based on the company node corresponding to the determined target company, and at least one target company subgraph is determined from the enterprise knowledge graph based on the target node and its node attribute and edge attribute.

As shown in FIG. 6, if the target company includes company 1, company 2, . . . , company n, then company 1, company 2, . . . , and company n may correspond to respective target company sub-graphs. Taking company 1 as an example, the node company 1, the node industry 1 having the first type of edge with the node company 1, the node region 1 having the second type of edge with the node company 1, and the node position 1 having the third type of edge with the node company 1, and node position category 1 having the fifth type of edge with node position 1 are extracted from the enterprise knowledge graph. The target company subgraph 1 includes node company 1, node industry 1, node region 1, node position 1, node position category 1, and the first type of edge between node company 1 and node industry 1, the second type of edge between node company 1 and node region 1, the third type of edge between node company 1 and node position 1, the fifth type of edge between node position 1 and node position category 1.

In some embodiments, the extracting the target company subgraph further includes aggregating an employee node attribute and an attribute of a fourth type of an edge attribute between an employee and a position to a position node.

In some embodiments, age, tax amount, educational background, and date of turnover/hiring are added to the position node that has a fourth type of edge with the employee node. In some embodiments, the aggregating the employee node attributes into the position node may include adding a vector represented by the employee node attribute and a vector represented by the attribute of a fourth type of edge between the employee and the position to the vector represented by the position node attribute, as an attribute of the position node in the target company subgraph. Specifically, the elements in the attribute vector of the position node may include the number of recruits and the number of leavers, the elements in the age vector may represent the number of people in each age group, the elements in the tax amount vector may represent each tax amount stage and the number of people corresponding to each stage, the elements in the education vector may represent each education stage and the corresponding number of people, and the elements in the turnover/hiring date vector may represent the date when the employee leaves and joins the job. For example, the education vector may be (1, 10, 2, 20), where 1 may represent a university degree and the number of the people in the university degree is 10, and 2 may represent a graduate degree and the number of the people in the graduate degree is 20.

By removing employee nodes from the target company subgraph and converging employee-related edge attributes to position nodes, the amount of data in the target company subgraph may be reduced, the amount of data input to the prediction model may be reduced, and the computational efficiency may be improved.

The target company subgraph is determined from the company knowledge map based on the preset conditions, irrelevant data is removed, and the amount of data is reduced, so that the relevant situation of the target company, especially the employment situation of the target company, can be more intuitively understood.

It should be noted that different embodiments may have different beneficial effects. In different embodiments, the possible beneficial effects may include any combination of one or more of the above, or any other possible beneficial effects that may be obtained.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for employment management in a smart city, which is realized by a system for employment management in a smart city based on Internet of Things, the system comprising a user platform, a service platform, a management platform;
the method being executed by the management platform, and the method comprising:
obtaining company-related information, wherein the company-related information includes at least one of regional information, industry information, company information, position information, and employee information;
determining a target industry and a target company based on the company-related information and a query condition, and transmitting the query condition to the management platform through the service platform based on the user platform, wherein the query condition is obtained based on the user platform;
predicting a turnover rate and a hiring rate of the target company based on company-related information of the target company;
returning the turnover rate and the hiring rate of the target company to the user platform through the service platform;
generating first warning information based on the turnover rate that meets a first preset requirement, and/or generating second warning information based on the hiring rate that meets a second preset requirement; and
returning the first warning information and/or the second warning information to the user platform based on the service platform.

2. The method of claim 1, wherein the management platform comprises a general management platform database, multiple management sub-platforms, and multiple sub-platform databases, wherein the multiple management sub-platforms are in one-to-one correspondence with the multiple sub-platform databases;
each of the multiple management sub-platforms includes at least one of a regional management sub-platform, an industry management sub-platform, a company management sub-platform, a position management sub-platform, and an employee management sub-platform of an enterprise.

3. The method of claim 2, wherein the obtaining company-related information comprises: obtaining the company-related information based on the multiple management sub-platforms, and transferring the company-related information to the general management platform database through the multiple sub-platform databases; and
the determining of a target industry and a target company based on the company-related information and a query condition includes:
determining the target industry and the target company based on the company-related information and the query condition by the general management platform database.

4. The method of claim 2, wherein the system for employment management in a smart city based on the Internet of Things further comprises a sensor network platform and an object platform; the object platform is used to obtain the company-related information, and transmit the company-related information to the multiple sub-platform databases based on the sensor network platform.

5. The method of claim 4, wherein the sensor network platform comprises multiple sensor network sub-platforms, and the multiple sensor network sub-platforms are in one-to-one correspondence with the multiple sub-platform databases.

6. The method of claim 1, wherein the query condition includes an industry query condition and a company query condition;
the determining of the target industry and target company based on the company-related information and the query condition includes:
determining the target industry based on the industry query condition;
determining the target company from the target industry based on the company query condition.

7. The method of claim 1, wherein the predicting the turnover rate and the hiring rate of the target company based on the company-related information of the target company comprises:
predicting the turnover rate and the hiring rate of the target company based on the company-related information of the target company through a prediction model; wherein the prediction model is a machine learning model.

8. The method of claim 7, wherein the predicting the turnover rate and the hiring rate of the target company based on the company-related information of the target company comprises:
building an enterprise knowledge graph based on the company-related information;
determining node attribute of a target node based on the company-related information of the target company;
obtaining a target company subgraph from the enterprise knowledge graph based on the node attribute of the target node; and
predicting the turnover rate and the hiring rate of the target company based on the processing of the target company subgraph by the prediction model.

9. A system for employment management in a smart city based on Internet of Things, comprising a user platform, a service platform, and a management platform; wherein
the management platform is configured to perform following operations, including;
obtaining company-related information, wherein the company-related information includes at least one of regional information, industry information, company information, position information, and employee information;
determining a target industry and a target company based on the company-related information and a query condition; and transmitting the query condition to the management platform through the service platform based on the user platform, wherein the query condition is obtained based on the user platform;
predicting a turnover rate and a hiring rate of the target company based on company-related information of the target company;
returning the turnover rate and the hiring rate of the target company to the user platform through the service platform;
generating first warning information based on the turnover rate that meets a first preset requirement, and/or generating second warning information based on the hiring rate that meets a second preset requirement; and
returning the first warning information and/or the second warning information to the user platform based on the service platform.

10. The system of claim 9, wherein the management platform comprises a management general platform database, multiple management sub-platforms, and multiple sub-platform databases, wherein, the multiple management sub-platforms are in one-to-one correspondence with the multiple sub-platform databases;
each of the multiple management sub-platforms includes at least one of regional management sub-platform, an industry management sub-platform, a company management sub-platform, a position management sub-platform, and an employee management sub-platform of an enterprise.

11. The system of claim 10, wherein the management platform is further configured to obtain the company-related information based on the multiple management sub-platforms, and transfer the company-related information to the general management platform database through the multiple sub-platform databases; and
the determining of a target industry and a target company based on the company-related information and a query condition includes:
determining the target industry and the target company based on the company-related information and the query condition by the general management platform database.

12. The system of claim 10, wherein the system for employment management in a smart city based on the Internet of Things further comprises a sensor network platform and an object platform; the object platform is used to obtain the company-related information, and transmit the company-related information to the multiple sub-platform databases based on the sensor network platform.

13. The system of claim 12, wherein the sensor network platform comprises multiple sensor network sub-platforms, and the multiple sensor network sub-platforms are in one-to-one correspondence with the multiple sub-platform databases.

14. The system of claim 9, wherein the query condition includes an industry query condition and a company query condition; and
the management platform is further configured to
determine the target industry based on the industry query condition;
determine the target company from the target industry based on the company query condition.

15. The system of claim 9, wherein the management platform is further configured to
predict the turnover rate and the hiring rate of the target company based on the company-related information of the target company through a prediction model; wherein the prediction model is a machine learning model.

16. The system of claim 15, wherein the management platform is further configured to
build an enterprise knowledge map based on the company-related information;
determine a node attribute of a target node based on the company-related information of the target company;
obtain a target company subgraph from the enterprise knowledge graph based on the node attribute of the target node; and
predict the turnover rate and the hiring rate of the target company based on the processing of the target company subgraph by the prediction model.

17. A non-transitory computer-readable storage medium, comprising a set of instructions, wherein when executed by at least one processor, the method of claim 1 is implemented.
